(19) United States
(12) Patent Application Publication
(10) Pub. No.: US 2026/0010186 A1
(43) Pub. Date: Jan. 8, 2026

(54) FLUID CIRCULATION SYSTEM, FLOW RATE CONTROL METHOD, CONTROL DEVICE, AND COMPUTER PROGRAM

(71) Applicant: SHINWA CONTROLS CO., LTD, Kawasaki-Shi (JP)

(72) Inventors: Tomoyoshi SASAFUCHI, Kawasaki-Shi (JP); Toru IKEGAMI, Kawasaki-Shi (JP)

(73) Assignee: SHINWA CONTROLS CO., LTD, Kawasaki-Shi (JP)

(21) Appl. No.: 18/996,051

(22) PCT Filed: Aug. 1, 2023
(86) PCT No.: PCT/JP2023/028122

§ 371 Date: Jan. 17, 2025

(30) Foreign Application Priority Data
Aug. 2, 2022 (JP) 2022-123588

(51) Int. Cl. G05D 23/19

(52) U.S. Cl. CPC G05D 23/1917

(57) ABSTRACT

A system according to an embodiment includes a fluid circulation apparatus 20 including a pump 22 and allowing a fluid to circulate by rotation of the pump, and a control device 30 controlling the fluid circulation apparatus 20. When the target flow rate for the fluid is changed, the control device 30 derives the changed rotation speed on the basis of the target flow rate and the flow rate of the fluid and the rotation speed of the pump 22 at the time of changing the target flow rate or the flow rate of the fluid and the rotation speed of the pump 22 in the predetermined period before changing the target flow rate, and changes the rotation speed of the pump 22 toward the changed rotation speed.

### TECHNICAL FIELD

Embodiments of the present invention relate to a fluid circulation system, a flow rate control method, a control device, and a computer program.

### BACKGROUND ART

There is known a temperature control system including a refrigeration apparatus having a compressor, a condenser, an expansion valve, and an evaporator, and a fluid circulation apparatus circulating a fluid such as water or brine, in which the fluid circulated by the fluid circulation apparatus is cooled by the evaporator of the refrigeration apparatus. The present applicant has previously proposed this type of system, for example, in Patent Literature 1 (JPB6053907).

### SUMMARY OF THE INVENTION

In a manufacturing plant, temperature conditions may be switched as a manufacturing process is switched. At this time, the flow rate of the fluid used for temperature control may be changed. Such a flow rate change is performed, for example, when it is desired to increase the refrigeration capacity for a temperature control target. In such a flow rate change, recently, extremely high responsiveness may be required.

When the flow rate of the fluid circulated by the fluid circulation apparatus is switched in the temperature control system described above, the flow rate of the fluid circulated by the fluid circulation apparatus may be controlled by PID control. In the PID control, responsiveness is improved by gain adjustment. However, even when gain adjustment is performed in the PID control, a recent high demand for responsiveness cannot be satisfied in some cases.

On the other hand, a feedforward control may be incorporated into a PID control system to improve responsiveness. In the feedforward control, since a large control amount can be input separately from the PID control, responsiveness can be improved. However, in the feedforward control, responsiveness may be impaired depending on the setting of the operation amount and the derivation procedure thereof. For example, when the flow path length is changed or the flow path arrangement condition is changed, it cannot be said that the feedforward set value determined under a certain condition is appropriate under other conditions. For example, in such a case, when the same set value is used under other conditions, a desirable control may not be performed.

Therefore, an object of the present invention is to provide a fluid circulation system, a flow rate control method, a control device, and a computer program capable of stably improving responsiveness at the time of switching a flow rate.

A fluid circulation system according to an embodiment of the present invention is a fluid circulation system including: a fluid circulation apparatus including a pump and allowing a fluid to circulate by rotation of the pump; and a control device controlling the fluid circulation apparatus, in which when a target flow rate for the fluid is changed, the control device derives a changed rotation speed based on the target flow rate and a flow rate of the fluid and a rotation speed of the pump at the time of changing the target flow rate or a flow rate of the fluid and a rotation speed of the pump in a predetermined period before changing the target flow rate, and changes the rotation speed of the pump toward the changed rotation speed.

A flow rate control method according to an embodiment of the present invention is a flow rate control method in a fluid circulation system including a fluid circulation apparatus including a pump and allowing a fluid to circulate by rotation of the pump, the flow rate control method including: a process of detecting whether a target flow rate for the fluid has been changed; and a process of, when the target flow rate for the fluid is changed, deriving a changed rotation speed based on the target flow rate and a flow rate of the fluid and a rotation speed of the pump at the time of changing the target flow rate or a flow rate of the fluid and a rotation speed of the pump in a predetermined period before changing the target flow rate, and changing the rotation speed of the pump toward the changed rotation speed.

A control device according to an embodiment of the present invention is a control device controlling a fluid circulation system including a fluid circulation apparatus including a pump and allowing a fluid to circulate by rotation of the pump, in which when a target flow rate for the fluid is changed, the control device derives a changed rotation speed based on the target flow rate and a flow rate of the fluid and a rotation speed of the pump at the time of changing the target flow rate or a flow rate of the fluid and a rotation speed of the pump in a predetermined period before changing the target flow rate, and changes the rotation speed of the pump toward the changed rotation speed.

A computer program according to an embodiment of the present invention is a computer program for controlling a fluid circulation system including a fluid circulation apparatus including a pump and allowing a fluid to circulate by rotation of the pump, the computer program configured to cause a computer to execute: a step of detecting whether a target flow rate for the fluid has been changed; and a step of, when the target flow rate for the fluid is changed, deriving a changed rotation speed based on the target flow rate and a flow rate of the fluid and a rotation speed of the pump at the time of changing the target flow rate or a flow rate of the fluid and a rotation speed of the pump in a predetermined period before changing the target flow rate, and changing the rotation speed of the pump toward the changed rotation speed.

According to the present invention, it is possible to stably improve the responsiveness at the time of switching the flow rate.

### BRIEF DESCRIPTION OF DRAWINGS

FIG. 1 is a diagram schematically illustrating a temperature control system as a fluid circulation system according to an embodiment.

FIG. 2 is a block diagram illustrating a functional configuration of a control device constituting the temperature control system of FIG. 1.

FIG. 3 is a flowchart for explaining an operation of the temperature control system of FIG. 1.

FIG. 4 is a flowchart for explaining an operation of the temperature control system of FIG. 1.

FIG. 5 is a view showing a graph for explaining an operation of a constituent device of the temperature control system of FIG. 1 and a flow rate control state.

FIG. 6 is a flowchart for explaining an operation of a temperature control system according to a modification.

FIG. 7 is a flowchart for explaining an operation of the temperature control system related to FIG. 6.

FIG. 8 is a diagram for explaining an application example of a temperature control system according to an embodiment or a modification.

### BEST MODE FOR CARRYING OUT THE INVENTION

Hereinafter, an embodiment of the present invention will be described.

### <Configuration of Temperature Control System>

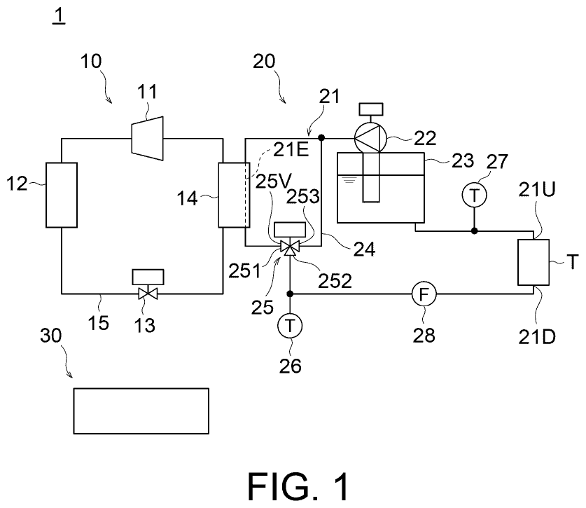

FIG. 1 is a schematic diagram of a temperature control system 1 as a fluid circulation system according to an embodiment. The temperature control system 1 illustrated in FIG. 1 includes a refrigeration apparatus 10, a fluid circulation apparatus 20, and a control device 30.

The refrigeration apparatus 10 controls the temperature of a fluid circulated by the fluid circulation apparatus 20 using a refrigerant. The fluid circulation apparatus 20 supplies the fluid whose temperature is controlled by the refrigeration apparatus 10 to a temperature control target T.

The fluid circulation apparatus 20 is configured to circulate the fluid having passed through the temperature control target T. The fluid returned from the temperature control target T is temperature-controlled again by the refrigeration apparatus 10. The fluid circulated in the fluid circulation apparatus 20 is, for example, brine, but may be another fluid such as water.

The control device 30 is configured to control the refrigeration apparatus 10 and the fluid circulation apparatus 20, and for example, sets a target temperature and a target flow rate of the fluid to be supplied to the temperature control target T according to an operation of a user, or controls each unit so that the state of the fluid becomes the set target temperature and the set target flow rate. Hereinafter, each unit of the temperature control system 1 will be described in detail.

The refrigeration apparatus 10 includes a compressor 11, a condenser 12, an expansion valve 13, and an evaporator 14. The compressor 11, the condenser 12, the expansion valve 13, and the evaporator 14 are connected by a pipe 15 in this order so as to circulate the refrigerant.

The compressor 11 is configured to compress the refrigerant in a low-temperature and low-pressure gas state flowing out from the evaporator 14 into a high-temperature and high-pressure gas state and supply the refrigerant to the condenser 12. The condenser 12 is configured to cool and condense the refrigerant compressed by the compressor 11 with, for example, cooling water, into a high-pressure liquid state at a predetermined cooling temperature and supply the refrigerant to the expansion valve 13. The cooling water passing through the condenser 12 may be water or other refrigerants. Note that the condenser 12 may be an air-cooled condenser.

The expansion valve 13 is configured to decompress the refrigerant supplied from the condenser 12 by expanding the refrigerant into a low-temperature and low-pressure gas-liquid mixed state and supply the refrigerant to the evaporator 14. The evaporator 14 heat-exchanges the refrigerant supplied from the expansion valve 13 with the fluid of the fluid circulation apparatus 20. The refrigerant heat-exchanged with the fluid is in a low-temperature and low-pressure gas state, flows out from the evaporator 14, and returns to the compressor 11. The refrigerant flowing out from the evaporator 14 is compressed again by the compressor 11.

The fluid circulation apparatus 20 includes a main flow path 21 having an inlet 21U and an outlet 21D, and the main flow path 21 connects each of the inlet 21U and the outlet 21D to the temperature control target T. The main flow path 21 has a heat exchange unit 21E between the inlet 21U and the outlet 21D, and causes the fluid received at the inlet 21U to flow to the outlet 21D through the heat exchange unit 21E.

The fluid circulation apparatus 20 heat-exchanges the fluid in the heat exchange unit 21E with the refrigerant in the evaporator 14, and then sends the fluid from the outlet 21D to the temperature control target T. The fluid circulation apparatus 20 receives the fluid having passed through the temperature control target T at the inlet 21U. The fluid circulation apparatus 20 causes the evaporator 14 to exchange heat again with the fluid flowing into the inlet 21U.

The fluid circulation apparatus 20 further includes a pump 22, a tank 23, a bypass flow path 24, a valve mechanism 25, a first temperature sensor 26, a second temperature sensor 27, and a flow rate sensor 28.

The pump 22 constitutes a part of the main flow path 21 and generates a driving force for causing the fluid to flow. The pump 22 is disposed in an upstream portion of the heat exchange unit 21E in the main flow path 21, but the position thereof is not particularly limited. The pump 22 is electrically connected to the control device 30, and the rotation speed is controlled by the control device 30. When the rotation speed of the pump 22 is increased or decreased, the flow rate of the fluid circulating in the fluid circulation apparatus 20 can be adjusted.

The tank 23 is also disposed in the upstream portion of the heat exchange unit 21E in the main flow path 21. The tank 23 is provided to store a certain amount of the fluid and constitutes a part of the main flow path 21. In the present embodiment, the pump 22 is disposed in the tank 23, but the pump 22 may be provided outside the tank 23.

The bypass flow path 24 connects the upstream portion and the downstream portion of the heat exchange unit 21E in the main flow path 21, and allows the fluid received from the upstream portion of the main flow path 21 to circulate. The valve mechanism 25 adjusts the flow rate of the fluid circulating in the heat exchange unit 21E in the main flow path 21 and the flow rate of the fluid circulating in the bypass flow path 24.

The valve mechanism 25 in the present embodiment includes a three-way valve 25V. The three-way valve 25V includes a first port 251, a second port 252, and a third port 253. A flow path from the first port 251 to the second port 252 constitutes a part of the main flow path 21. An upstream end opening of the bypass flow path 24 is connected to the downstream portion of the pump 22 and the upstream portion of the heat exchange unit 21E in the main flow path 21, and the downstream end opening is connected to the third port 253 of the three-way valve 25V.

The three-way valve 25V can adjust a ratio between the flow rate of the fluid flowing into the first port 251 and flowing out from the second port 252 and the flow rate of the fluid flowing into the third port 253 and flowing out from the second port 252. As a result, a ratio between the flow rate of the fluid circulating in the heat exchange unit 21E in the main flow path 21 and the flow rate of the fluid circulating in the bypass flow path 24 can be adjusted. Note that although the valve mechanism 25 includes the three-way valve 25V, a configuration in which two or more two-way valves are combined may be used. The three-way valve 25V may be a motor valve, and the two-way valve may be an electromagnetic valve.

The first temperature sensor 26 detects the temperature of the fluid circulating in the downstream portion of the heat exchange unit 21E in the main flow path 21. Specifically, the first temperature sensor 26 detects the temperature of the fluid circulating in the downstream portion of a connection position with the downstream end of the bypass flow path 24 in the main flow path 21, specifically, the temperature of the fluid circulating in the downstream portion of the three-way valve 25V.

The second temperature sensor 27 detects the temperature of the fluid circulating in the upstream portion of the heat exchange unit 21E in the main flow path 21. Specifically, the second temperature sensor 27 detects the temperature of the fluid circulating in a portion between the inlet 21U and the tank 23 in the main flow path 21. Note that the detection position of the second temperature sensor 27 may not be in the above aspect, and may be in the tank 23, a portion between the tank 23 and the heat exchange unit 21E in the main flow path 21, or the like.

The flow rate sensor 28 detects the flow rate of the fluid circulating in the downstream portion of a connection position with the downstream end of the bypass flow path 24 in the main flow path 21, specifically, the flow rate of the fluid circulating in the downstream portion of the three-way valve 25V. That is, the flow rate sensor 28 detects the flow rate of the fluid supplied to the temperature control target T.

The first temperature sensor 26, the second temperature sensor 27, and the flow rate sensor 28 described above are electrically connected to the control device 30, and information detected by each sensor (temperature information, flow rate information) is transmitted to the control device 30.

The control device 30 is a controller that controls the operations of the refrigeration apparatus 10 and the fluid circulation apparatus 20, and may be configured by, for example, a computer having a CPU, a ROM, and the like. In this case, various processes are performed according to the program stored in the ROM. Note that the control device 30 may include another processor or an electric circuit (for example, field programmable gate alley (FPGA) or the like).

The control device 30 controls the refrigeration apparatus 10 and the fluid circulation apparatus 20 so as to control the temperature of the fluid to a target temperature set for the fluid circulated by the fluid circulation apparatus 20, for example. At this time, the control device 30 controls the rotation speed of the compressor 11 and the opening degree of the expansion valve 13 in the refrigeration apparatus 10. The control device 30 controls the rotation speed of the pump 22 and the operation of the valve mechanism 25 in the fluid circulation apparatus 20. Hereinafter, the configuration of the control device 30 will be described in detail.

### <Configuration of Control Device>

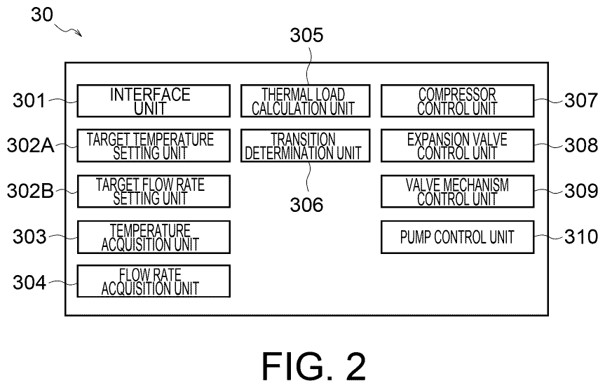

FIG. 2 is a block diagram illustrating a functional configuration of the control device 30. As illustrated in FIG. 2, the control device 30 includes an interface unit 301, a target temperature setting unit 302A, a target flow rate setting unit 302B, a temperature acquisition unit 303, a flow rate acquisition unit 304, a thermal load calculation unit 305, a transition determination unit 306, a compressor control unit 307, an expansion valve control unit 308, a valve mechanism control unit 309, and a pump control unit 310. Most of these functional units are realized, for example, by executing a program.

Note that the control device 30 may include, for example, one computer or a plurality of computers. In the case of including a plurality of computers, the plurality of functional units described above may be distributed to a plurality of computers. The control device 30 controls the refrigeration apparatus 10 and the fluid circulation apparatus 20, and specifically controls the refrigeration apparatus 10 and the fluid circulation apparatus 20 using any of the plurality of functional units described above. Hereinafter, each functional unit will be described in detail.

The interface unit 301 receives information from the outside and supplies the information to the outside. The interface unit 301 acquires information on the target temperature of the fluid circulated by the fluid circulation apparatus 20 by, for example, an input from an operation means operated by a user or an input from the outside of the device, and supplies the information to, for example, the target temperature setting unit 302A. The interface unit 301 also acquires information such as an operation start command, a stop command from a user, a target flow rate of the fluid circulated by the fluid circulation apparatus 20, and the like. When acquiring the information on the target flow rate, the interface unit 301 supplies the information to the pump control unit 310 and the like.

The target temperature setting unit 302A internally sets and holds information on the target temperature acquired from the interface unit 301 as the target temperature. The target temperature setting unit 302A supplies the acquired information on the target temperature to the thermal load calculation unit 305, the transition determination unit 306, the compressor control unit 307, the expansion valve control unit 308, the valve mechanism control unit 309, and the like.

The target flow rate setting unit 302B internally sets and holds information on the target flow rate acquired from the interface unit 301 as the target flow rate. The target flow rate setting unit 302B supplies the acquired information on the target flow rate to the transition determination unit 306, the pump control unit 310, and the like.

The temperature acquisition unit 303 acquires information on the temperature of the fluid detected by the first temperature sensor 26 and information on the temperature of the fluid detected by the second temperature sensor 27. The temperature acquisition unit 303 acquires temperature information constantly or at a predetermined cycle, and supplies the temperature information of the fluid circulating downstream of the heat exchange unit 21E acquired from the first temperature sensor 26 to the transition determination unit 306, the compressor control unit 307, the expansion valve control unit 308, the valve mechanism control unit 309, and the like. The temperature acquisition unit 303 supplies information on the temperature of the fluid circulating upstream of the heat exchange unit 21E acquired from the second temperature sensor 27 to the thermal load calculation unit 305.

The flow rate acquisition unit 304 acquires flow rate information of the fluid detected by the flow rate sensor 28. The flow rate acquisition unit 304 acquires flow rate information constantly or at a predetermined cycle, and supplies the acquired flow rate information to the thermal load calculation unit 305, the pump control unit 310, and the like.

The thermal load calculation unit 305 calculates a thermal load (heat input amount) for setting the temperature of the fluid before flowing into the heat exchange unit 21E in the main flow path 21 to the target temperature set by the target temperature setting unit 302A. Specifically, the thermal load calculation unit 305 calculates the thermal load based on the target temperature, the temperature information acquired from the second temperature sensor 27, and the flow rate information of the fluid acquired from the flow rate acquisition unit 304.

The thermal load can be obtained, for example, by multiplying a difference between the target temperature and the temperature specified by the second temperature sensor 27 by the flow rate of the fluid, the density of the fluid, and the specific heat. The thermal load calculation unit 305 may derive the thermal load on the basis of the above calculation as an example. The thermal load calculation unit 305 provides the calculated thermal load to the compressor control unit 307.

The transition determination unit 306 acquires information on the target temperature from the target temperature setting unit 302A, temperature information on the fluid circulating downstream of the heat exchange unit 21E from the first temperature sensor 26, information on the target flow rate from the target flow rate setting unit 302B, and flow rate information on the fluid circulating in the downstream portion of the three-way valve 25V from the flow rate sensor 28, in other words, the fluid supplied to the temperature control target T. The transition determination unit 306 determines a control mode for controlling the temperature of the fluid circulating downstream of the heat exchange unit 21E to the target temperature on the basis of the information on the target temperature and the temperature information on the fluid circulating downstream of the heat exchange unit 21E. The transition determination unit 306 in the present embodiment can select a desired control mode from a plurality of control modes related to temperature control on the basis of the information on the target temperature from the target temperature setting unit 302A and the temperature information from the first temperature sensor 26. The control mode is not particularly limited, but may be a feedback control, a control incorporating a feedforward control and a feedback control, or the like.

The transition determination unit 306 determines a control mode for controlling the flow rate of the fluid circulating in the fluid circulation apparatus 20 to the target flow rate on the basis of the information on the target flow rate from the target flow rate setting unit 302B and the flow rate information from the flow rate sensor 28. The transition determination unit 306 in the present embodiment determines a steady control or a manual control as a control mode, and supplies information on the determined control mode to the pump control unit 310.

Specifically, the transition determination unit 306 first determines to perform control in a steady control as a control mode related to a flow rate control during the first operation. That is, when the operation start is instructed after the target temperature and the target flow rate are set in the temperature control system 1 in a stopped state, the transition determination unit 306 determines to perform control in a steady control. Thereafter, the transition determination unit 306 determines whether to maintain the steady control or transition to the manual control when the target flow rate is changed. The manual control is processing performed to improve the responsiveness of the flow rate control. Specifically, the transition determination unit 306 performs the manual control when a difference between the changed target flow rate and the flow rate of the fluid at the time of changing the target flow rate or the flow rate of the fluid in the predetermined period before changing the target flow rate is equal to or more than a flow rate threshold. The flow rate threshold is preferably a relatively large value, and may be, for example, 1.0 L/min. The flow rate threshold may be 0.5 L/min or more. In the present embodiment, the difference between the target flow rate and the flow rate of the fluid at the time of changing the target flow rate is compared with the flow rate threshold. In this case, the flow rate of the fluid at the time of change may be, for example, the flow rate of the fluid detected by the flow rate sensor 28 at the time of change or immediately after change.

In the above steady control, the rotation speed of the pump 22 is controlled by a feedback control based on the difference between the target flow rate and the current flow rate specified from the flow rate information from the flow rate sensor 28 by using the information on the target flow rate from the target flow rate setting unit 302B and the flow rate information from the flow rate sensor 28. At this time, the rotation speed of the pump 22 is increased or decreased so that the current flow rate matches the target flow rate. On the other hand, in the above manual control, first, the changed rotation speed is derived on the basis of the target flow rate and the flow rate of the fluid and the rotation speed of the pump 22 at the time of changing the target flow rate or the flow rate of the fluid and the rotation speed of the pump 22 in the predetermined period before changing the target flow rate, and then the rotation speed of the pump 22 is changed toward the above changed rotation speed. Details of the manual control will be described later.

The transition determination unit 306 maintains the steady control when the difference between the changed target flow rate and the flow rate of the fluid at the time of changing the target flow rate or the flow rate of the fluid in the predetermined period before changing the target flow rate is less than the flow rate threshold. The transition determination unit 306 determines the transition to the steady control when a predetermined condition is satisfied after the transition to the manual control. Specifically, the transition determination unit 306 determines the transition to the steady control when an absolute value of the difference between the target flow rate and the flow rate of the fluid detected by the flow rate sensor 28 is equal to or less than a determination threshold after the rotation speed of the pump 22 is changed in the manual control. The determination threshold may be, for example, 1/20 or more and 5/20 of the absolute value of the difference between the flow rate of the fluid detected by the flow rate sensor 28 and the target flow rate at the time of change to the target flow rate. The inventors of the present application have found that the responsiveness of the flow rate control can be improved by switching the control on the basis of the state of the flow rate of the fluid, not on the basis of whether or not the rotation speed of the pump 22 matches the changed rotation speed, and have adopted such a configuration.

Note that when the manual control is performed, it is desirable that the rotation speed of the pump 22 is changed within 1 second from the timing when the target flow rate is changed. It goes without saying that the timing of changing the rotation speed of the pump 22 is, strictly speaking, the timing of inputting a control signal to the pump 22.

The compressor control unit 307 acquires information on the control mode related to the temperature control determined by the transition determination unit 306. The compressor control unit 307 controls the rotation speed of the compressor 11 on the basis of the acquired control mode.

The expansion valve control unit 308 also acquires information on the control mode related to the temperature control determined by the transition determination unit 306, similarly to the compressor control unit 307. The expansion valve control unit 308 controls the opening degree of the expansion valve 13 on the basis of the acquired control mode.

The valve mechanism control unit 309 acquires information on the control mode related to the temperature control determined by the transition determination unit 306 and information on the control mode related to the flow rate control. The valve mechanism control unit 309 controls the valve mechanism 25 on the basis of the acquired control mode. In the present embodiment, the valve mechanism control unit 309 basically closes the bypass flow path 24, and forms a state where the fluid circulates only in the main flow path 21. Note that the valve mechanism control unit 309 may form a state where the fluid circulates in both the main flow path 21 and the bypass flow path 24. In this case, the valve mechanism control unit 309 holds the ratio between the flow rate of the fluid circulating in the heat exchange unit 21E in the main flow path 21 and the flow rate of the fluid circulating in the bypass flow path 24 at a constant value.

The pump control unit 310 acquires information on the control mode related to the flow rate control from the transition determination unit 306, information on the target flow rate from the interface unit 301, and flow rate information from the flow rate sensor 28. When the control mode related to the flow rate control acquired from the transition determination unit 306 is the steady control, the pump control unit 310 controls the rotation speed of the pump 22 by a feedback control based on a difference between the target flow rate and the current flow rate specified from the flow rate information from the flow rate sensor 28. The rotation speed of the pump 22 is increased or decreased so that the current flow rate matches the target flow rate. The above feedback control performed in the steady control is PID control, and may be P control, PI control, or PD control.

On the other hand, when the control mode related to the flow rate control acquired from the transition determination unit 306 is the manual control, as described above, the pump control unit 310 derives a changed rotation speed on the basis of the target flow rate and the flow rate of the fluid and the rotation speed of the pump 22 at the time of changing the target flow rate or the flow rate of the fluid and the rotation speed of the pump 22 in the predetermined period before changing the target flow rate, and changes the rotation speed of the pump 22 toward the above changed rotation speed.

Specifically, when the flow rate of the fluid in the predetermined period before changing the target flow rate is designated as Q1, the rotation speed of the pump 22 in the predetermined period before changing the target flow rate is designated as N1, the target flow rate is designated as Q2, and the changed rotation speed is designated as N2, the pump control unit 310 in the present embodiment derives the changed rotation speed (N2) on the basis of the following equation (1).

$$N 2 = Q 2 \times ( N 1 / Q 1 ) \qquad ( 1 )$$

In the present embodiment, the flow rate Q1 of the fluid in the predetermined period before changing the above target flow rate is a moving average value of flow rates of the fluid at a plurality of points in the predetermined period. The rotation speed N1 of the pump in the predetermined period before changing the above target flow rate is a moving average value of rotation speeds of the pump 22 at a plurality of points in the predetermined period. The control device 30 calculates and updates Q1 as the moving average value of flow rates of the above fluid and N1 as the moving average value of rotation speeds of the pump 22 at a predetermined interval in the pump control unit 310. When the execution of the manual control is determined, the pump control unit 310 derives the changed rotation speed N2 by using Q1 as the moving average value of flow rates of the fluid, N1 as the moving average value of rotation speeds of the pump 22, and the target flow rate Q2.

More specifically, the control device 30 calculates and updates, at a predetermined interval, a rotation speed arithmetic coefficient α obtained by dividing Q1 as the moving average value of flow rates of the fluid by N1 as the moving average value of rotation speeds of the pump 22 in the pump control unit 310. When the execution of the manual control is determined, the pump control unit 310 substitutes the latest rotation speed arithmetic coefficient α into (N1/Q1) in the above equation (1) to derive the changed rotation speed (N2). The above predetermined interval is not particularly limited, and may be, for example, 1.5 seconds. The above predetermined interval may be 1 second or more and 10 seconds or less, and may be 1 second or more and 5 seconds or less. The above predetermined interval coincides with a predetermined period for calculating the moving average value. The number of samples of the moving average value in the predetermined period is not particularly limited, and may be, for example, 5 or more and 15 or less.

In the present embodiment, the pump control unit 310 calculates the moving average value of flow rates of the fluid on the basis of the flow rate information from the flow rate sensor 28. When the moving average value of rotation speeds of the pump 22 is calculated, the pump control unit 310 in the present embodiment calculates the rotation speed of the pump 22 from the frequency of an input voltage to an inverter that supplies power to the pump 22. The rotation speed (RPM) of the pump 22 is specified by (120×(frequency of input voltage))/motor pole number. Note that the pump control unit 310 may directly acquire the rotation speed of the pump 22 from a rotation detector such as an encoder and calculate the moving average value using the rotation speed.

As described above, the pump control unit 310 derives a changed rotation speed and changes the rotation speed of the pump 22 toward the above changed rotation speed. Changing the rotation speed of the pump 22 toward the above changed rotation speed means setting the target rotation speed of the pump 22 to the above changed rotation speed and bringing the current rotation speed of the pump 22 close to the above changed rotation speed.

Note that, in the present embodiment, as Q1 in

“N2=Q2×(N1/Q1)”

of the above equation (1), the moving average value of flow rates of the fluid at a plurality of points in the predetermined period before changing the target flow rate is used, and as N1, the moving average value of rotation speeds of the pump 22 at a plurality of points in the predetermined period before changing the target flow rate is used. However, Q1 may be the flow rate of the fluid at the time of changing the target flow rate, and N1 may be the rotation speed of the pump 22 at the time of changing the target flow rate. Q1 may be the flow rate of the fluid at a certain point in a predetermined period before changing the target flow rate, and N1 may be the rotation speed of the pump 22 at a certain point in a predetermined period before changing the target flow rate.

### <Operation of Temperature Control System>

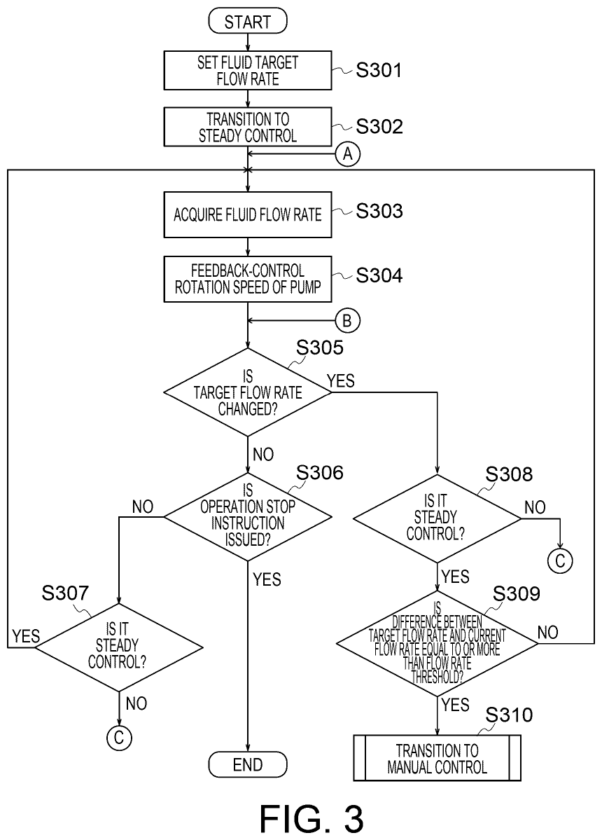

FIG. 3 is a flowchart for explaining an example of an operation of the temperature control system 1. Hereinafter, an example of the operation of the temperature control system 1 will be described with reference to FIG. 3. Hereinafter, an example of an operation at the time of flow rate control performed in the temperature control system 1 will be described.

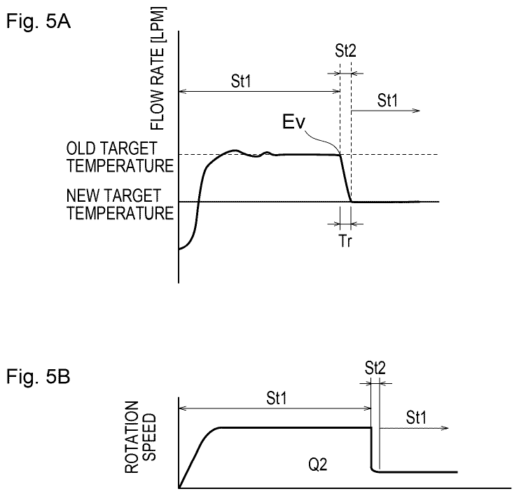

The operation illustrated in FIG. 5 is started by generation of an operation start command. When the operation start command is generated, the control device 30 first sets a target flow rate of the fluid circulated by the fluid circulation apparatus 20 in step S301. Specifically, the target flow rate of the fluid is set and held by the target flow rate setting unit 302B in the control device 30. The target flow rate setting unit 302B acquires information on the target flow rate from the interface unit 301. At this time, although not illustrated, information on the target temperature of the fluid is also sent from the interface unit 301 to the target temperature setting unit 302A.

Next, in step S302, the control device 30 determines the control mode by the transition determination unit 306. On the basis of the first operation, the transition determination unit 306 determines to perform control in a steady control as a control mode related to a flow rate control. This transition to the steady control starts a feedback control on the pump 22. At this time, the transition determination unit 306 also determines a control mode related to temperature control, and supplies information on the determined control mode to the compressor control unit 307, the expansion valve control unit 308, and the valve mechanism control unit 309. The compressor control unit 307 starts control of the rotation speed of the compressor 11 in order to control the temperature of the fluid to the target temperature, and the expansion valve control unit 308 starts control of the opening degree of the expansion valve 13 in order to control the temperature of the fluid to the target temperature. At this time, the valve mechanism control unit 309 gradually closes the bypass flow path 24 by the valve mechanism 25, and forms a state where the fluid circulates only in the main flow path 21.

Next, in step S303, the control device 30 causes the flow rate acquisition unit 304 to acquire information on the flow rate of the fluid detected by the flow rate sensor 28. That is, the control device 30 acquires information on the flow rate of the fluid circulating downstream of the heat exchange unit 21E in the main flow path 21 and flowing out from the three-way valve 25V. Note that step S303 corresponds to an example of the detection process (step).

Next, in step S304, the control device 30 feedback-controls the rotation speed of the pump 22 so that the flow rate of the fluid circulating downstream of the heat exchange unit 21E in the main flow path 21 matches the target flow rate on the basis of the information on the flow rate of the fluid detected by the flow rate sensor 28.

Next, the control device 30 determines whether the target flow rate is changed in step S305. When the target flow rate is not changed, the control device 30 determines whether an operation stop instruction is issued in stop S306. When the operation stop instruction is not issued, the control device 30 determines whether the current control mode is the steady control in step S307. When it is determined that the control mode is the steady control in step S307, the process returns to step S303, and the feedback control for the rotation speed of the pump 22 is repeated.

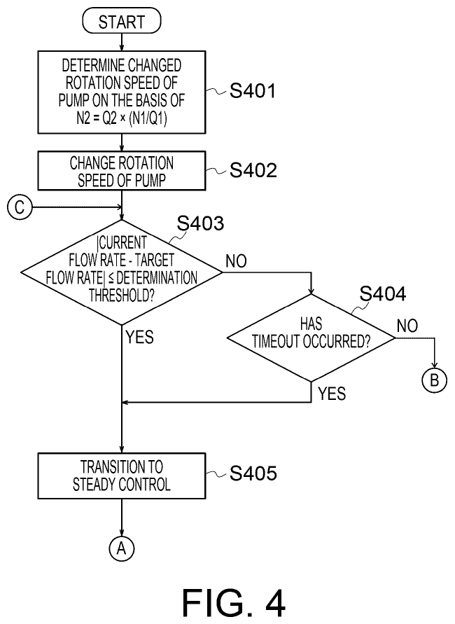

Note that a case where it is not determined in step S307 that the control mode is the steady control means that the control mode is the manual control. As will be described later, in the process of the manual control, the change of the target flow rate in step S305 and the occurrence of the operation stop instruction in step S306 are checked in the middle of the process. When the target flow rate is not changed during the manual control (NO in step S306) and the operation stop instruction is also not issued (NO in step S307), it is determined in step S307 that the control mode is not the steady control, and then the process returns to a specific monitoring process in the manual control in FIG. 4 described later via “C” in FIG. 3.

When it is determined in step S305 that the target flow rate has been changed, the control device 30 determines whether the current control mode is the steady control in step S308. When it is determined in step S308 that the control mode is the steady control, the control device 30 determines in step S309 whether the difference between the changed target flow rate and the flow rate of the fluid at the time of changing the target flow rate is equal to or more than the flow rate threshold. When it is determined in step S309 that the difference between the changed target flow rate and the flow rate of the fluid at the time of changing the target flow rate is equal to or more than the flow rate threshold, the control device 30 determines to perform the flow rate control by the manual control in step S310. On the other hand, when it is not determined in step S309 that the difference between the changed target flow rate and the flow rate of the fluid at the time of changing the target flow rate is equal to or more than the flow rate threshold, the process returns to step S303, and the pump 22 is controlled by a feedback control by the steady control.

A case where it is not determined in step S308 that the control mode is the steady control means that the control mode is the manual control as in step S307 described above. When the change of the target flow rate in step S305 is checked in the middle of the process of the manual control and the target flow rate is changed, the process proceeds to step S308. However, it is determined in step S308 that the control mode is not the steady control, and the determination of the transition to a new manual control (step S310) is not made. When it is determined in step S308 that the control mode is not the steady control, similarly to a case where it is determined in step S307 that the control mode is not the steady control, the process returns to a specific monitoring process in the manual control in FIG. 4 described later via “C” in FIG. 3. That is, this means that overlapping manual control is not performed. Note that, when it is determined in step S306 that the operation stop instruction has been issued, the operation of the temperature control system 1 is stopped (END).

Next, FIG. 4 is a flowchart for explaining a manual control. Hereinafter, the operation in the case of transition to the manual control will be described with reference to FIG. 4.

First, in step S401, the control device 30 determines the changed rotation speed (N2) on the basis of the above equation (1):

“N2=Q2×(N1/Q1)”.

Specifically, the pump control unit 310 substitutes the above-described latest rotation speed arithmetic coefficient α into (N1/Q1) in the above equation (1) to derive the changed rotation speed (N2). The rotation speed arithmetic coefficient α is a value obtained by dividing Q1 as the moving average value of flow rates of the fluid by N1 as the moving average value of rotation speeds of the pump 22.

In step S402, the control device 30 causes the pump control unit 310 to change the rotation speed of the pump 22 toward the changed rotation speed N2.

Thereafter, the control device 30 determines whether or not to transition to the steady control by the transition determination unit 306 in step S403. Specifically, in step S403, when the absolute value of the difference between the target flow rate and the flow rate of the fluid detected by the flow rate sensor 28 is equal to or less than the determination threshold, the transition determination unit 306 determines the transition to the steady control. When it is not determined in step S403 that the absolute value of the difference between the target flow rate and the flow rate of the fluid detected by the flow rate sensor 28 is equal to or less than the determination threshold, it is determined in step S404 whether or not a timeout has occurred. Whether or not a timeout has occurred is determined by whether or not a predetermined time has elapsed from the process in step S402. In the present embodiment, even when it is determined in step S404 that a timeout has occurred, the transition determination unit 306 determines the transition to the steady control.

When the transition to the steady control is determined in step S405, the process of the control device 30 proceeds to step S303 in FIG. 3 via “A” in FIG. 4. In this case, the rotation speed of the pump 22 is controlled by a feedback control. On the other hand, when it is not determined in step S403 that the absolute value of the difference between the target flow rate and the flow rate of the fluid detected by the flow rate sensor 28 is equal to or less than the determination threshold and it is not determined in step S404 that a timeout has occurred, the process of the control device 30 proceeds to step S305 in FIG. 3 via “B” in FIG. 4. In this case, the change of the target flow rate (step S305) and the occurrence of the operation stop instruction (step S306) are checked in the middle of the process of the manual control.

When the target flow rate is not changed during the manual control (NO in step S306) and the operation stop instruction is also not issued (NO in step S307), it is determined in step S307 that the control mode is not the steady control, and then the process returns to a specific monitoring process (process from step S403) in the manual control in FIG. 4 via “C” in FIG. 3. When the change of the target flow rate in step S305 is checked in the middle of the process of the manual control and the target flow rate is changed, the process proceeds to step S308. It is determined in step S308 that the control mode is not the steady control, and the process returns to a specific monitoring process in the manual control in FIG. 4 via “C” in FIG. 3.

FIG. 5 is a view showing a graph for explaining an operation of a constituent device of the temperature control system 1 and a flow rate control state. FIG. 5 shows a change in the flow rate of the fluid and the rotation speed of the pump 22 when the flow rate control transitions to the steady control→the manual control→the steady control described above. In each graph, the horizontal axis is the time axis. FIG. 5(A) shows a state of the flow rate of the fluid circulated by the fluid circulation apparatus 20 that changes with the lapse of time. FIG. 5(B) shows a state of the rotation speed of the pump 22 that changes with the lapse of time (control mode).

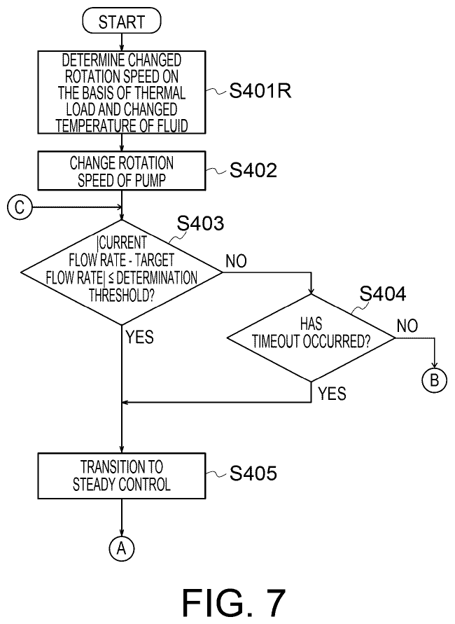

The “old target flow rate” shown in FIG. 7(A) means a target flow rate of the fluid circulated by the fluid circulation apparatus 20 set at the start of operation. St1 in FIG. 5 indicates the steady control state. At this time, the rotation speed of the pump 22 is controlled by a feedback control.

The “new target flow rate” in FIG. 5 indicates the changed target flow rate. The change to the new target flow rate is performed at a time point indicated by a reference sign Ev in the drawing, and manual control St2 is performed accordingly. In manual control St2, the rotation speed of the pump 22 is lowered toward the changed rotation speed Q2.

Thereafter, when the absolute value of the difference between the target flow rate and the flow rate of the fluid detected by the flow rate sensor 28 is equal to or less than the determination threshold, the state transitions to steady control St1. The inventors of the present application have confirmed that an arrival time Tr can be significantly shortened by performing the manual control when the target flow rate is greatly raised as described above.

The temperature control system 1 as the fluid circulation system according to the present embodiment described above includes a fluid circulation apparatus 20 including a pump 22 and allowing a fluid to circulate by rotation of the pump, and a control device 30 controlling the fluid circulation apparatus 20. When the target flow rate for the fluid is changed, the control device 30 derives the changed rotation speed on the basis of the target flow rate and the flow rate of the fluid and the rotation speed of the pump 22 at the time of changing the target flow rate or the flow rate of the fluid and the rotation speed of the pump 22 in the predetermined period before changing the target flow rate, and changes the rotation speed of the pump 22 toward the changed rotation speed.

In the temperature control system 1, the changed rotation speed corresponding to the target flow rate is derived on the basis of the actual flow rate of the fluid and the actual rotation speed of the pump 22 at the time of or before changing the target flow rate of the fluid. As a result, the changed rotation speed becomes a target value with high reliability regarding control to the target flow rate. After the changed rotation speed is derived, the rotation speed of the pump 22 is changed toward the changed rotation speed. In this case, the responsiveness of the flow rate control can be improved as compared with the case of the feedback control. That is, in the feedback control, the control operation amount of the pump up to the target flow rate is derived stepwise by a plurality of calculations based on the difference between the target flow rate and the current flow rate. Since the flow rate of the fluid gradually approaches the target flow rate, the responsiveness may not be necessarily favorable. On the other hand, in the temperature control system 1, when the changed rotation speed is set as a target value, the control operation amount of the pump 22 is changed toward a single target valve in a linear function manner or in a step input manner. Therefore, the responsiveness of the control to the pump 22 that meets the target flow rate can be improved. Therefore, it is possible to stably improve the responsiveness at the time of switching the flow rate.

In the present embodiment, when the flow rate of the fluid at the time of changing the target flow rate or the flow rate of the fluid in the predetermined period before changing the target flow rate is designated as Q1, the rotation speed of the pump 22 at the time of changing the target flow rate or the rotation speed of the pump 22 in the predetermined period before changing the target flow rate is designated as N1, the target flow rate is designated as Q2, and the changed rotation speed is designated as N2, the control device 30 derives the changed rotation speed N2 based on the following equation (1).

$$N 2 = Q 2 \times ( N 1 / Q 1 ) \qquad ( 1 )$$

In this configuration, since the changed rotation speed to be a target value is derived by a simple relational expression using a proportional relationship between the flow rate and the pump rotation speed, the calculation load can be suppressed. As a result, the responsiveness of the flow rate control can be improved.

In the present embodiment, as Q1, the moving average value of flow rates of the fluid at a plurality of points in the predetermined period before changing the target flow rate is used, and as N1, the moving average value of rotation speeds of the pump 22 at a plurality of points in the predetermined period before changing the target flow rate is used. In this configuration, the influence of the noise component of the flow rate of the fluid to be detected and the rotation speed of the pump 22 can be suppressed. Therefore, the changed rotation speed as the target value can be appropriately derived, and the responsiveness of the flow rate control can be improved.

The control device 30 calculates and updates the moving average value of flow rates of the fluid and the moving average value of rotation speeds of the pump 22 in a predetermined period at a predetermined interval. In this configuration, parameters (the flow rate and the rotation speed) necessary for deriving the changed rotation speed as the target value can be immediately extracted.

More specifically, the control device 30 calculates and updates, at a predetermined interval, the rotation speed arithmetic coefficient α obtained by dividing the moving average value of flow rates of the fluid by the moving average value of rotation speeds of the pump 22. In this configuration, the calculation speed of the changed rotation speed can also be increased, and the information amount of the parameters (the flow rate and the rotation speed) necessary for deriving the changed rotation speed as the target value can be suppressed.

The control device 30 transitions to a steady control after changing the rotation speed of the pump 22 to the changed rotation speed, and the control device 30 adjusts the rotation speed of the pump 22 by a feedback control based on a difference between a flow rate of the fluid detected by the flow rate sensor 28 and the target flow rate in the steady control. In this configuration, favorable responsiveness to the target flow rate and favorable control accuracy can be secured by performing the steady control accompanied by the feedback control after the manual control focusing on responsiveness.

When the target flow rate for the fluid is changed, the control device 30 controls the rotation speed of the pump 22 to the changed rotation speed when a difference between the target flow rate and the flow rate of the fluid at the time of changing the target flow rate or the flow rate of the fluid in the predetermined period before changing the target flow rate is equal to or more than a flow rate threshold, that is, performs the manual control. When the change amount from the current fluid flow rate to the target flow rate is relatively small, the manual control may not be necessarily effective from the viewpoint of responsiveness. By determining whether or not to perform the manual control using the flow rate threshold from such a viewpoint, according to the present configuration, not only when the target flow rate is greatly increased, but also favorable responsiveness of the flow rate control can be secured as the entire system.

Although the embodiments and modifications of the present invention have been described above, the present invention is not limited to the above-described embodiments, and various modifications can be further made to the above-described embodiments and modifications.

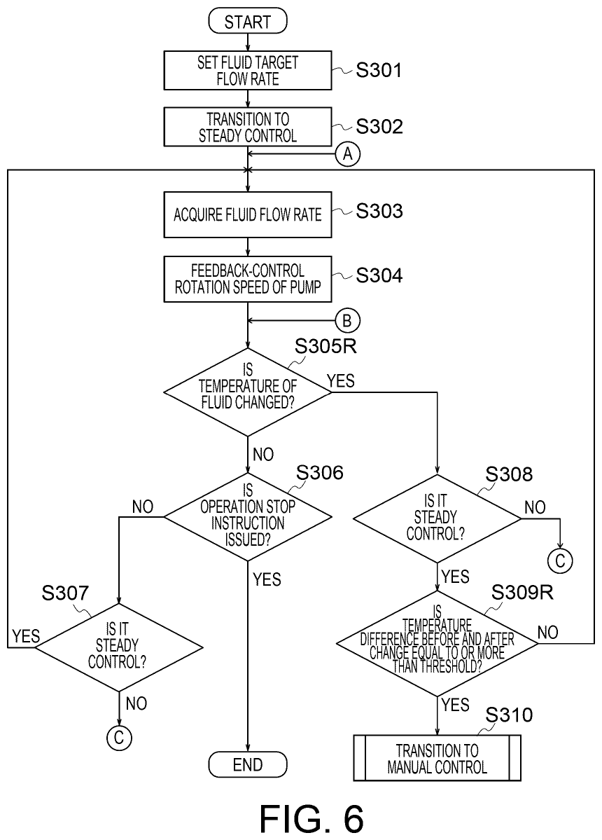

FIG. 6 is a flowchart for explaining an operation of a temperature control system according to a modification. In the above-described embodiment, whether or not to transition to the manual control is determined according to the target flow rate. On the other hand, in the operation of the modification illustrated in FIG. 6, whether or not to transition to the manual control is determined according to the change in the temperature of the fluid before flowing into the heat exchange unit 21E in the main flow path 21. Specifically, whether or not to transition to the manual control is determined according to the magnitude of the change in the temperature of the fluid detected by the second temperature sensor 27.

The processes in steps S301 to S304 in the operation illustrated in FIG. 6 are the same as the processes in FIG. 3. In this modification, in step S305R after the feedback control is performed in step S304, the control device 30 determines whether the temperature of the fluid before flowing into the heat exchange unit 21E (fluid temperature before temperature adjustment) has changed. The determination in step S305R is made by comparing the temperatures of the fluids detected by the second temperature sensor 27 at different detection timings. More specifically, for example, the temperature of the fluid detected by the second temperature sensor 27 during the process in step S305R may be compared with the temperature of the fluid detected by the second temperature sensor 27 before the process. The temperature of the fluid detected by the second temperature sensor 27 before the above process may be a moving average value. The temperature of the fluid detected by the second temperature sensor 27 during the above process may be a moving average value. When the change in the temperature of the fluid is not detected in step S305R, the process proceeds to step S306, and the feedback control is repeated during the steady control.

On the other hand, when the change in the temperature of the fluid is detected in step S305R, it is determined in step S308 whether the control mode is the steady control, and in the case of the steady control, the control device 30 determines whether the absolute value of the difference between the temperatures of the fluids before and after the change is equal to or more than the threshold in step S309R. The temperature difference is obtained from the temperature of the fluid compared in step S305R. When it is determined in step S309R that the absolute value of the difference between the temperatures of the fluids before and after the change is equal to or more than the threshold, the transition to the manual control is determined (step S310).

Referring to FIG. 7, in the manual control in this modification, in step S401R, the control device 30 determines the changed rotation speed as the target value of the pump rotation speed on the basis of the thermal load (calculated by the thermal load calculation unit 305) and the changed temperature of the fluid.

Specifically, the thermal load when a temperature t1 of the fluid before flowing into the heat exchange unit 21E is set to a currently set target temperature t2 is calculated by, for example, multiplying the flow rate of the fluid, the density of the fluid, the specific heat of the fluid, the temperature difference before control (absolute value of t1-t2), a predetermined coefficient, and the like. The flow rate of the fluid corresponding to the thermal load for controlling the temperature t1 of the fluid before flowing into the heat exchange unit 21E to the currently set target temperature t2 can be derived by dividing the thermal load calculated as described above by a value obtained by multiplying the density of the fluid, the specific heat of the fluid, the temperature difference before control (absolute value of t1-t2) and the predetermined coefficient. When the pump rotation speed corresponding to the derived flow rate is set to the changed rotation speed, the thermal change of the temperature control target T that has caused the temperature change of the fluid is canceled, and the temperature of the temperature control target T can be appropriately controlled.

Specifically, the control device 30 determines the changed rotation speed on the basis of the thermal load for controlling the changed temperature of the fluid to the target temperature, the changed temperature of the fluid, and the target temperature, and operates so that the state where the temperature control target T is appropriately heated is returned early. More specifically, the control device 30 may derive the changed rotation speed N2 by using

“N2=Q2×(N1/Q1) (1)”,

where the derived flow rate is designated as Q2, the current flow rate is designated as Q1, and the current rotation speed of the pump 22 is designated as N1. Note that the flow rate Q1 at this time and the current rotation speed N1 of the pump 22 may be moving average values as in the above-described embodiment. That is, the control device 30 may determine the changed rotation speed on the basis of the thermal load for controlling the changed temperature of the fluid to the target temperature, the changed temperature of the fluid, the target temperature, the flow rate of the fluid and the rotation speed of the pump 22 before change or the flow rate of the fluid and the rotation speed of the pump 22 in a predetermined period before changing the temperature of the fluid.

In the present modification, for example, the changed rotation speed is derived in step 401R by the calculation as described above, and thereafter, the same process as those in steps S402 to S405 described in FIG. 4 is performed. In such a modification, when the temperature of the fluid detected by the second temperature sensor 27 changes, the process for maintaining the temperature control target T as a desired temperature at an early stage by the manual control is performed. Note that, in step S309R in FIG. 6, the transition to the manual control may be determined when the thermal load is equal to or more than a predetermined value.

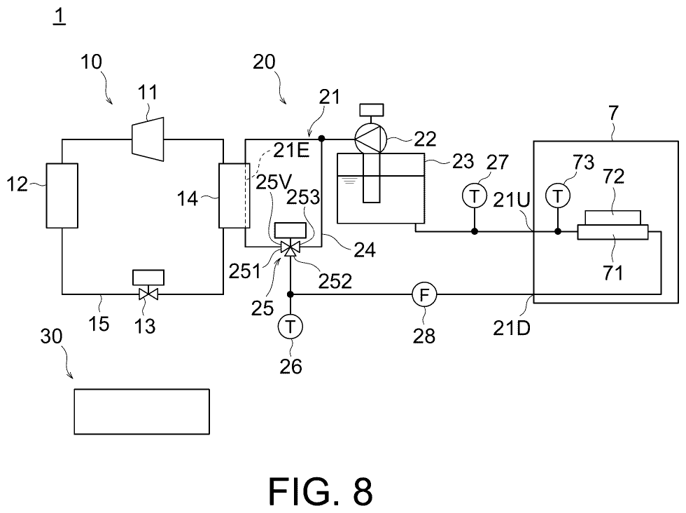

FIG. 8 is a diagram for explaining an application example of a temperature control system according to an embodiment or a modification. In FIG. 8, the temperature control system 1 is connected to an etching apparatus as the temperature control target T. The etching apparatus of FIG. 8 includes an electrostatic chuck 71. The fluid whose temperature is controlled from the temperature control system 1 passes through the electrostatic chuck 71 and returns to the temperature control system 1. A wafer 72 is held by the electrostatic chuck 71. The electrostatic chuck 71 is connected to the inlet 21U and the outlet 21D of the main flow path 21 in the temperature control system 1 via a flow path inside the etching apparatus. The etching apparatus further includes an internal temperature sensor 73 that detects the temperature of the fluid flowing out from the electrostatic chuck 71 inside the apparatus. Strictly speaking, the temperature control target T in this example is the electrostatic chuck 71 or the wafer 71 in the etching apparatus 7.

Note that the operation described with reference to FIGS. 6 and 7 may be performed on the basis of a change in the temperature of the fluid detected by the internal temperature sensor 73. That is, whether or not to perform the manual control may be determined according to the temperature of the fluid detected by the internal temperature sensor 73. Specifically, whether or not to perform the manual control may be determined according to the temperature of the fluid in the etching apparatus 7 as an external device after heat exchange with the electrostatic chuck 71 in the etching apparatus 7 which is an external apparatus and before flowing into the heat exchange unit 21E detected by the internal temperature sensor 73. Note that the internal temperature sensor 73 may detect the temperature of the inside or the outer surface of the electrostatic chuck 71. In the example of FIG. 8, the temperature control system 1 integrally includes the etching apparatus 7 which is an external device as the temperature control target T, but the temperature control system 1 may be integrated with another external device. For example, the temperature control system 1 may be integrated with another semiconductor manufacturing apparatus such as a resist processing apparatus, an inspection apparatus such as a semiconductor tester, a molding apparatus including a mold other than the semiconductor field, or the like. Even in such another configuration, whether or not to perform the manual control may be determined on the basis of the temperature detected by an element corresponding to the internal temperature sensor 73 in the external device.

1. A fluid circulation system comprising:
a fluid circulation apparatus including a pump and allowing a fluid to circulate by rotation of the pump; and
a control device controlling the fluid circulation apparatus,
wherein when a target flow rate for the fluid is changed, the control device derives a changed rotation speed based on the target flow rate and a flow rate of the fluid and a rotation speed of the pump at the time of changing the target flow rate or a flow rate of the fluid and a rotation speed of the pump in a predetermined period before changing the target flow rate, and changes the rotation speed of the pump toward the changed rotation speed.

2. The fluid circulation system according to claim 1, wherein when the flow rate of the fluid at the time of changing the target flow rate or the flow rate of the fluid in the predetermined period before changing the target flow rate is designated as Q1,
the rotation speed of the pump at the time of changing the target flow rate or the rotation speed of the pump in the predetermined period before changing the target flow rate is designated as N1,
the target flow rate is designated as Q2, and
the changed rotation speed is designated as N2,
the control device derives the changed rotation speed N2 based on the following equation (1).
$$N 2 = Q 2 \times ( N 1 / Q 1 ) \qquad ( 1 )$$

3. The fluid circulation system according to claim 1, wherein the flow rate of the fluid in the predetermined period before changing the target flow rate is a moving average value of flow rates of the fluid at a plurality of points, and
the rotation speed of the pump in the predetermined period before changing the target flow rate is a moving average value of rotation speeds of the pump at a plurality of points.

4. The fluid circulation system according to claim 3, wherein the control device calculates and updates the moving average value of flow rates of the fluid and the moving average value of rotation speeds of the pump at a predetermined interval.

5. The fluid circulation system according to claim 4, wherein the control device calculates and updates a rotation speed arithmetic coefficient obtained by dividing the moving average value of flow rates of the fluid by the moving average value of rotation speeds of the pump at the predetermined interval.

6. The fluid circulation system according to claim 5, wherein the control device transitions to a steady control after changing the rotation speed of the pump to the changed rotation speed, and
the control device adjusts the rotation speed of the pump by a feedback control based on a difference between a flow rate of the fluid detected by a flow rate sensor and the target flow rate in the steady control.

7. The fluid circulation system according to claim 6, wherein the feedback control is P control, PI control, PD control, or PID control.

8. The fluid circulation system according to claim 1, wherein when the target flow rate for the fluid is changed, the control device controls the rotation speed of the pump to the changed rotation speed when a difference between the target flow rate and the flow rate of the fluid at the time of changing the target flow rate or the flow rate of the fluid in the predetermined period before changing the target flow rate is equal to or more than a flow rate threshold.

9. (canceled)

10. A flow rate control method in a fluid circulation system including a fluid circulation apparatus including a pump and allowing a fluid to circulate by rotation of the pump, the flow rate control method comprising:
a process of detecting whether a target flow rate for the fluid has been changed; and
a process of, when the target flow rate for the fluid is changed, deriving a changed rotation speed based on the target flow rate and a flow rate of the fluid and a rotation speed of the pump at the time of changing the target flow rate or a flow rate of the fluid and a rotation speed of the pump in a predetermined period before changing the target flow rate, and changing the rotation speed of the pump toward the changed rotation speed.

11. A control device controlling a fluid circulation system including a fluid circulation apparatus including a pump and allowing a fluid to circulate by rotation of the pump,
wherein when a target flow rate for the fluid is changed, the control device derives a changed rotation speed based on the target flow rate and a flow rate of the fluid and a rotation speed of the pump at the time of changing the target flow rate or a flow rate of the fluid and a rotation speed of the pump in a predetermined period before changing the target flow rate, and changes the rotation speed of the pump toward the changed rotation speed.

12. (canceled)
